(19) United States
(12) Patent Application Publication
(10) Pub. No.: US 2008/0143971 A1
(43) Pub. Date: Jun. 19, 2008

(54) System and method for light collection and homogenization

(75) Inventor: Duane Scott Dewald, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/641,259

(22) Filed: Dec. 19, 2006

(51) Int. Cl. G03B 21/00

(52) U.S. Cl. 353/31

(57) ABSTRACT

System and method for collecting and homogenizing light from large etendue light sources for use in projection display systems. An embodiment comprises a light source, an integrating lens optically coupled to the light source, and an auxiliary lens optically coupled to the light source and positioned in a light path of an illumination system after the light source. The integrating lens condenses light provided by the light source and the auxiliary lens focuses light incident on an outer periphery of the auxiliary lens towards an optical axis of the illumination system and passes light incident on an optical center portion of the auxiliary lens substantially unaffected. The auxiliary lens redirects light striking its periphery back towards the optical axis of the illumination system, thereby increasing the amount of usable light.

### TECHNICAL FIELD

The present invention relates generally to a system and method for displaying images, and more particularly to a system and method for collecting and homogenizing light from large etendue light sources for use in projection display systems.

### BACKGROUND

The etendue of an optical system, such as a projection display system, characterizes the spread of the light in area and angle. Etendue can be a function of the size of the light source, as well as a separation from the light source and lenses in the projection display system. Projection display systems with large etendue can be less efficient than similar display systems with small etendue since a larger percentage of light produced by the light source is not effectively projected onto a display plane, yielding images with lower brightness.

A commonly used light source in projection display systems, such as digital micromirror device (DMD) based projection display systems, is an electric arc lamp. Electric arc lamps can produce a large amount of light with small etendue. Other types of light sources for projection display systems are solid-state light sources, such as light-emitting diodes (LED) and laser diodes, which have started to appear on the market. Solid-state light sources offer advantages such as lower power consumption, longer life, rapid on-off switching, and so forth. However, solid-state light sources tend to have larger etendue than electric arc lamps, which can reduce the amount of usable light.

Prior art techniques for improving the overall efficiency of a projection display system with large etendue light sources can involve the placement of rod integrators and collimating lenses and/or fly-eye integrators into the optical path of the projection display system. These techniques help improve efficiency by capturing light that is divergent from the optical path of the projection display system and redirecting it back into the optical path.

### SUMMARY OF THE EMBODIMENTS

These and other problems are generally solved or circumvented, and technical advantages are generally achieved, by embodiments of the present invention which provide a system and method for collecting and homogenizing light from large etendue light sources for use in projection display systems.

In accordance with an embodiment, an illumination system is provided. The illumination system includes a light source, an integrating lens optically coupled to the light source, and an auxiliary lens optically coupled to the light source and positioned in a light path of the illumination system after the light source. The integrating lens condenses light provided by the light source, while the auxiliary lens focuses light incident on an outer periphery of the auxiliary lens towards an optical axis of the illumination system and passes light incident on an optical center portion of the auxiliary lens substantially unaffected.

In accordance with another embodiment, a display system is provided. The display system includes a light source that produces multiple colors of light, an array of light modulators optically coupled to the light source, and a controller coupled to the array of light modulators and to the light source. The array of light modulators produces images on a display plane by modulating light from the light source based on image data and the controller provides light commands to the light source and loads image data into the array of light modulators. The light source includes a light element, an integrating lens optically coupled to the light element, and an auxiliary lens optically coupled to the light element and positioned in a light path of the light source after the light element. The integrating lens condenses light provided by the light element and the auxiliary lens focuses light incident on an outer periphery of the auxiliary lens towards an optical axis of the light source and passes light incident on an optical center portion of the auxiliary lens substantially unaffected.

In accordance with another embodiment, a method of manufacturing a display system is provided. The method includes installing a light source, installing a spatial light modulator in the light path of the multiple colors of light, installing a lens system in the light path of the multiple colors of light between the light source and the spatial light modulator, and installing a controller. The installing of the light source includes installing a light element to produce the multiple colors of light, installing an integrating lens to condense light produced by the light element, and installing an auxiliary lens in the light path of the multiple colors of light after the light element to focus light incident on an outer periphery of the auxiliary lens towards an optical axis of the light source and to pass light incident on an optical center of the auxiliary lens substantially unaffected.

An advantage of an embodiment is increased light capture. This can allow for greater image brightness from a given light source. Alternatively, this can permit a greater separation between the collimator lens and the light source such as an LED, which can permit for greater cooling of the light source. The better cooling of the light source can afford improved efficiency and longer life.

A further advantage of an embodiment is that it allows the use of standard optical components. The use of standard, readily available optical components can minimize the cost of implementing the embodiment, and increase the deployment of the embodiment.

Yet another advantage of an embodiment is a reduction in the drop off of light capture efficiency drop off over distance. This permits higher efficiency for all colors used in the projection display system.

The foregoing has outlined rather broadly the features and technical advantages of embodiments of the present invention in order that the detailed description of the invention that follows may be better understood. Additional features and advantages of embodiments of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a through 1c are diagrams of portions of projection display systems, illustrating the etendue of various light sources;

FIG. 2 is a diagram of an optical system of a projection display system that utilizes a prior art technique to help improve light capture efficiency;

FIG. 3 is a diagram of an exemplary projection display system;

FIG. 4 is a diagram of a sequence of events in the manufacture of an exemplary projection display system;

FIGS. 5a through 5c are diagrams of exemplary auxiliary lenses and the effect of an auxiliary lens on light;

FIGS. 6a through 6c are diagrams of portions of light engines of exemplary projection display systems, where auxiliary lenses are used to help improve light capture efficiency;

FIGS. 7a through 7c are diagrams of exemplary auxiliary lenses; and

FIGS. 8a through 8d are diagrams of exemplary auxiliary lens and fly-eye integrator combinations.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a projection display system using a solid-state light source, such as an LED. The embodiments may also be applied, however, to other projection display systems where there is a desire for increased light capture efficiency. The projection display systems can use a wide variety of light sources, such as electric arc lamps, laser diodes, phosphor coated laser diodes, and so forth. The embodiments can further be applied to other optical systems for which there is a desire to increase light capture efficiency.

The diagram shown in FIG. 1a illustrates a portion of an optical system for a projection display system that makes use of an electric arc lamp 105 as its light source. An actual portion of the electric arc lamp 105 that produces light, a light element 106, can be small. With a small light element 106, a majority of light exiting the arc lamp 105 can be focused onto a focal point (‘FCL PT’) 115, such as a light modulator, using lens 110.

The diagram shown in FIG. 1b illustrates a portion of an optical system for a projection display system that makes use of an LED 120 as its light source. An actual portion of the LED 120 that produces light, a light element 121, can be relatively large when compared to the light element 106 of the electric arc lamp 105. As a result, a smaller percentage of the light can be focused onto the focal point 115. This can reduce the amount of light that the lens 110 can effectively focus, thereby reducing the amount of useful light in the projection display system.

A diagram shown in FIG. 1c illustrates a portion of an optical system of a projection display system that makes use of multiple LEDs 120. In many applications, a single LED 120 does not provide adequate light to produce images of sufficient brightness, perhaps due to a lack of brightness of the LED 120 or the LED's large etendue. Therefore, in a number of projection display systems, multiple LEDs can be arranged in arrays to increase the light output of the projection display system's light source. The diagram illustrates a light source with two LEDs 120, however, other light sources may utilize a different number of LEDs. Although multiple LEDs 120 can increase the light output, the etendue is also increased. Therefore, the amount of light that can be effectively focused by the lens 110 may not increase in proportion with the number of LEDs 120.

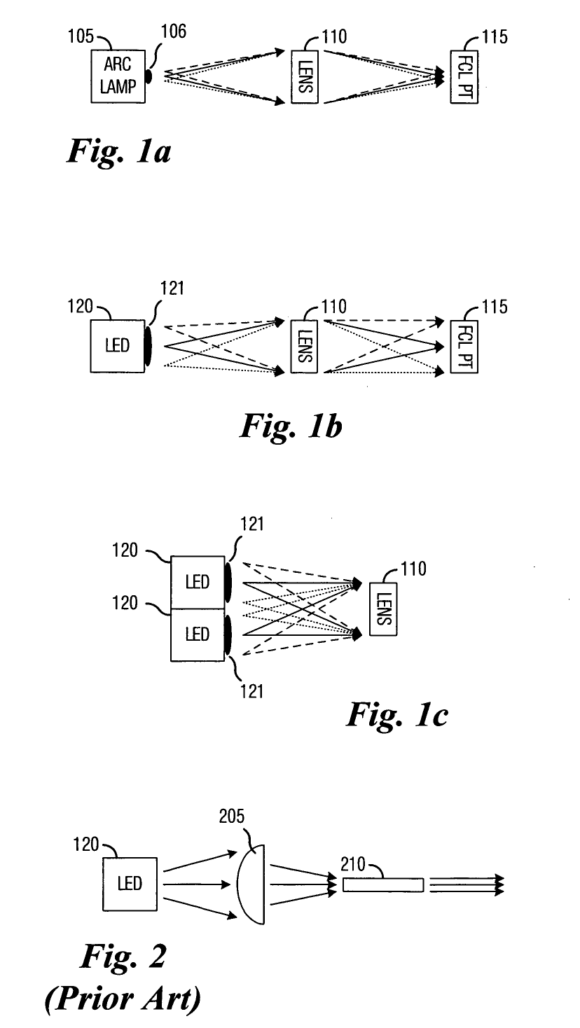

It is possible to use a rod integrator and collimating lens(es) to help increase the light gathering efficiency. The rod integrator can effectively condense light at its input, while the collimating lens gathers light at its input side and produces substantially parallel light beams at its output side. As an example, U.S. Pat. No. 6,139,156, entitled “Light Source Device and Projection Type Display Apparatus,” granted Oct. 31, 2000, which is incorporated herein by reference, discloses an optical arrangement that includes a rod integrator and collimating lenses. A diagram shown in FIG. 2 illustrates a portion of an optical system of a projection display system. The optical system includes one or more LEDs 120, a collimating lens 205 (or lenses), and a rod integrator 210. The collimating lens 205 produces substantially parallel light beams from light produced by the LED 120 and the rod integrator 210 condenses the light from the collimating lens 205. The use of the collimating lens 205 and the rod integrator 210 can increase the amount of useful light produced by the LED 120. The light output of the rod integrator 210 can then be provided to a remainder of the optical system of the projection display system.

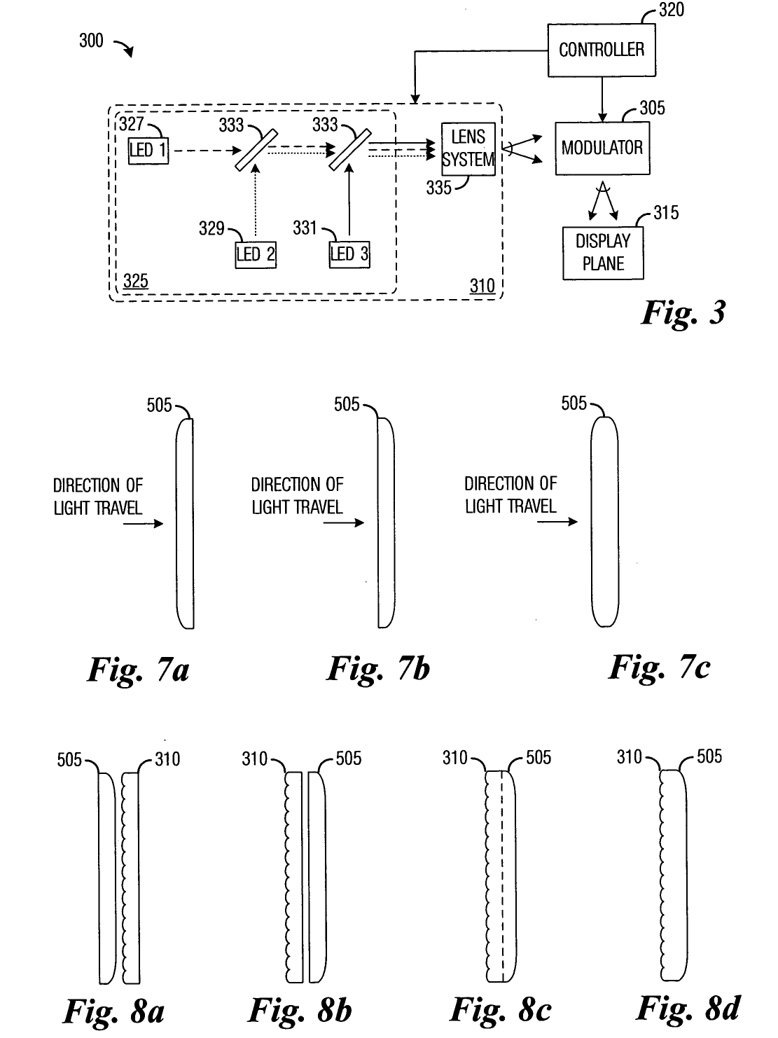

A diagram shown in FIG. 3 illustrates the projection display system 300 with a detailed view provided on a portion of the projection display system 300 that used in providing illumination. The projection display system includes a spatial light modulator (‘modulator’) 305. Preferably, the modulator 305 can be a digital micromirror device (DMD). However, the modulator 305 can also be a reflective or transmissive LCD panel, a liquid crystal on silicon (LCOS) panel, and so forth. The modulator 305, depending on image data, modulates light from a light engine 310 onto a display plane 315 of the projection display system 300.

A DMD contains a large number of positional micromirrors, with each micromirror's position (mirror state) being dependent upon image data corresponding to that micromirror. Depending on the image data, a micromirror will typically be in one of two states, a first position reflecting light from a light engine 310 onto a display plane 315 of the projection display system 300 and a second position reflecting light away from the display plane 315. The operation of the micromirrors in the DMD 305 is integrated over time by a user's eye into images.

A controller 320 can be responsible for the operation of both the light engine 310 and the DMD 305. The controller 320 can issue light commands to the light engine 310 to have the light engine 310 produce light of the appropriate color, intensity, duration, and so forth, to illuminate the modulator 305. The controller 320 can issue mirror commands to set the pixels of modulator 305. Additionally, the controller 320 can control the loading of the image data into the modulator 305, which is used to set the state of each pixel of the image. The projection display system 300 may include other components not shown in FIG. 3, including a memory for storing image data, color sequences, conversion values, and so on.

The light engine 310 can include a light source 325 and a lens system 335. The light source 325 can include a wideband light source, such as an electric arc lamp, or multiple narrowband light sources. As shown in FIG. 3, the light source 325 includes three LEDs, a first LED “LED 1” 327, a second LED “LED 2” 329, and a third LED “LED 3” 331. According to an embodiment, each of the three LEDs produces light of a different wavelength. For example, the first LED 327 can produce a red colored light, the second LED 329 can produce a green colored light, and the third LED 331 can produce a blue colored light. Depending on the colors used in the projection display system 300, the number of LEDs used in the light source 325 can vary as well as the color of light that each LED produces. For example, a four-color multiprimary projection display system can have four LEDs. Furthermore, each LED shown in FIG. 3 may be replaced with more than one LED, to increase the amount of light produced by the light source 325, for instance.

The light source 325 can also include dichroic filters 333, which can pass light if the light is originating from a first direction and is of a specific wavelength while reflecting light from a second direction and/or is of a different wavelength. Dichroic filters are also referred to as wavelength separating filters. The combination of the LEDs 327, 329, and 331, and the dichroic filters 333 can produce the necessary colors of light for the projection display system 300. The light from the light source 325 can be focused, homogenized, filtered, and so forth by the lens system 335 prior to being projected onto the DMD 305. The lens system 335 can contain one or more lenses required to achieve the desired optical performance. Although the lens system 335 is shown in FIG. 3 as being disjoint from the light source 325, some or all of the lens elements of the lens system 335 may be placed inside the light source 325. Therefore, the illustration of the disjoint lens system 335 and light source 325 should not be construed as being limiting to either the scope or the spirit of the embodiments.

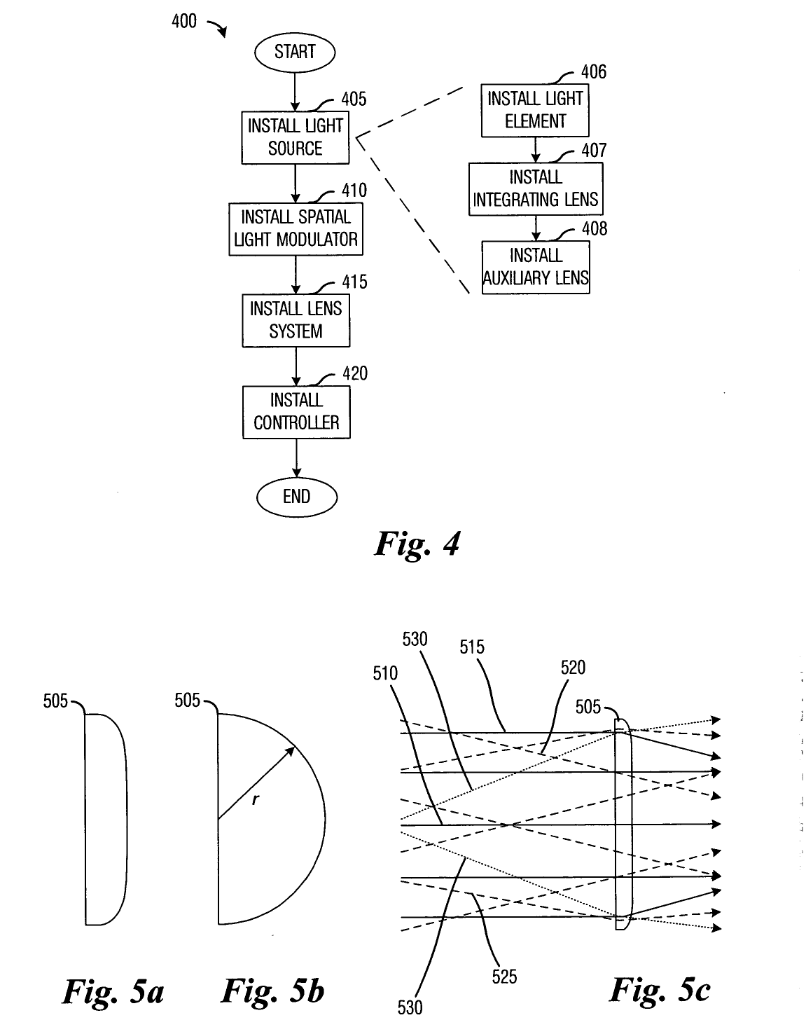

With reference now to FIG. 4, there is shown a diagram illustrating a sequence of events 400 in the manufacture of an exemplary projection display system. The manufacture of a projection display system may begin with installing a light source, which may produce multiple colors of light (block 405). The installing of the light source may include installing a light element(s) (block 406), installing an integrating lens(es) (block 407), and installing an auxiliary lens(es) (block 408).

The manufacture can continue with installing a spatial light modulator, such as a DMD in the light path of the multiple colors of light produced by the light source (block 410). After installing the spatial light modulator, a lens system may be installed in between the auxiliary lens and the spatial light modulator (block 415). A controller for the projection display system may then be installed (block 420).

With reference now to FIGS. 5a through 5c, there are shown diagrams illustrating cross-sectional views of exemplary auxiliary lenses and how an auxiliary lens affects light passing through the auxiliary lens. An auxiliary lens 505 can be an aspheric lens (also commonly referred to as an aspherical lens), as shown in FIG. 5a, with a center portion that is relatively flat and a curvature that increases towards the lens edge. An aspheric lens can have a curvature that is continuously changing. An example of an aspheric surface can be a surface of rotation of a parabola, hyperbola, or general polynomial. Alternatively, the auxiliary lens 505 may be a spherical lens, as shown in FIG. 5b. A spherical lens can have a radius r that remains constant. According to an embodiment, the auxiliary lens 505 should be of relatively high order, a third, fourth, or fifth order (or more) aspheric lens, for example, so that the relatively flat center portion comprises a large percentage of the overall lens area. The appropriate order of the auxiliary lens 505 can depend on factors such as the separation between the light source 325 and the lens system 335, the focal length of the lenses used in the projection display system, required cooling performance for the light source 325, and so forth.

The diagram shown in FIG. 5c displays light traveling relatively parallel to the axis of the auxiliary lens 505 and passing through the relatively flat center portion of the auxiliary lens 505, such as light beam 510, may pass through unaffected. Relatively parallel light beams passing through a curved edge portion of the auxiliary lens 505, such as light beam 515, can be focused towards the lens axis. Light beams traveling at a relatively small angle with respect to the lens axis, such as light beams 520 and 525, may be focused towards the lens axis and if their angle of incidence is sufficiently small, the light beams may pass through the center of lens 505 with only a small deflection or none at all. Light beams traveling at a relatively large angle with respect to the lens axis, such as light beams 530, may also be focused towards the lens axis. However, their angle of incidence can be too large to be redirected back into the optical path of the projection display system.

The auxiliary lens 505 can be formed from glass or plastic, preferably optical grade glass or plastic. The auxiliary lens 505 can be shaped to a desired profile from a block of glass or plastic by cutting and polishing or the auxiliary lens 505 can be cast (molded) to a desired profile. Furthermore, the auxiliary lens 505 can be a single lens or it can be formed from multiple lenses.

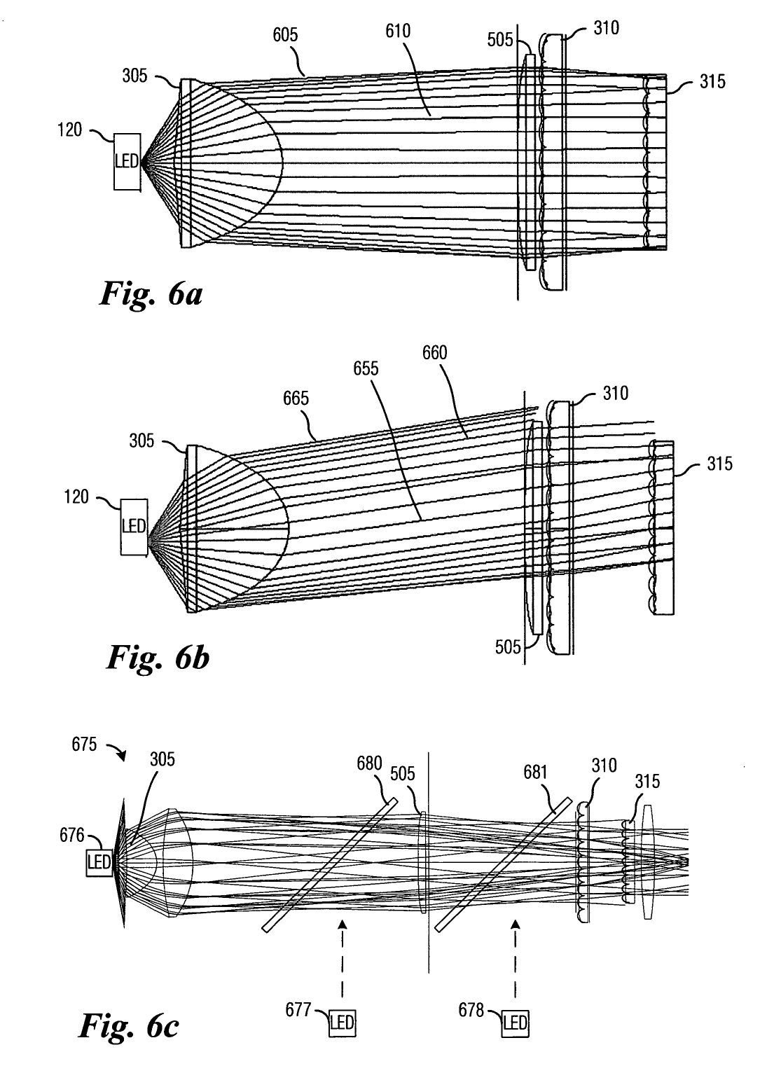

The diagram shown in FIG. 6a illustrates a portion of a light engine of an exemplary projection display system. The light engine includes an LED 120, a collimator lens 305, a first fly-eye integrator 310 and a second fly-eye integrator 315. Also included is an auxiliary lens 505 located in front of the first fly-eye integrator 310. A fly-eye integrator (the first fly-eye integrator 310 and the second fly-eye integrator 315) contains multiple facets arranged in an array and homogenizes the light from the light source. A separation between the auxiliary lens 505 and the fly-eye integrator 310 can be a function of the optical properties (order, focal length, and so forth) of the auxiliary lens 505 and the fly-eye integrator 310, and so forth.

The diagram shown in FIG. 6a traces light originating from a center of a light element of the LED 120. Light beams close to the lens axis of the lenses (the collimator lens 305, the first fly-eye integrator 310, the second fly-eye integrator 315, and the auxiliary lens 505), such as light beam 610, pass substantially unaffected through a relatively flat portion of the auxiliary lens 505. Light beams close to the curved outer edge of the auxiliary lens 505, such as light beam 605, can be focused by the auxiliary lens 505 back towards the optical axis of the lenses and can be recaptured by the first fly-eye integrator 310 and the second fly-eye integrator 315. Without the auxiliary lens 505, these light beams may be lost, thereby reducing the light efficiency of the projection display system.

The diagram shown in FIG. 6b traces light originating from an outer edge of a light element of the LED 120. The light beams strike the auxiliary lens 505 with a certain angle of incidence. Light beams close to the optical axis of the lenses, such as light beam 655, either pass through the relatively flat portion of the auxiliary lens 505 or the curved outer edge of the auxiliary lens 505 and can be captured by the first fly-eye integrator 310. Light beams further away from the lens axis of the lenses, such as light beam 660, can pass through the curved outer edge of the auxiliary lens 505 and can be focused by the auxiliary lens 505. However, depending on the angle of incidence, the auxiliary lens 505 may or may not be able to refocus all of the light beams back onto the first fly-eye integrator 310. Light beams that are far away from the lens axis of the lenses, such as light beam 665, can miss the auxiliary lens and the first fly-eye integrator 310 altogether.

The diagram shown in FIG. 6c illustrates a portion of a multi-color LED light engine 675 of a projection display system. As shown in the diagram, the light engine 675 includes three LEDs 676, 677, and 678 with each LED capable of producing light of a specific wavelength. For example, the LED 676 can produce red colored light, the LED 677 can produce green colored light, and the LED 678 can produce blue colored light. In a different projection display system, a light engine may have a different number of LEDs, which may produce the same or different colors as well as number of lights. For clarity, the diagram displays light beams from a single LED, LED 676. The light engine 675 includes dichroic filters 680 and 681 to combine the light produced by the three LEDs into a single path of light.

Positioned between dichroic filter 680 and dichotic filter 681 can be an auxiliary lens 505. The positioning of the auxiliary lens 505 so far in advance of the first fly-eye integrator 310 and the second fly-eye integrator 315 can permit the light from one or more LEDs to bypass the auxiliary lens 505. For example, the light from the LED 678 does not pass through the auxiliary lens 505. If the auxiliary lens 505 is moved to the right of the dichroic filter 680, then light from both the LED 677 and the LED 678 will bypass the auxiliary lens 505. A reason to bypass the auxiliary lens 505 may be that a particular LED's etendue may be sufficiently small so the effects of the auxiliary lens 505 is not needed. Although shown positioned between the dichroic filters 680 and 681, the auxiliary lens 505 can be positioned in front of both dichroic filters 680 and 681 or after both dichroic filters 680 and 681, for example.

In a typical optical system, such as those shown in FIGS. 3a and 3b, as the distance between the collimator and the fly-eye integrators is increased, the amount of light captured decreases. In an optical system with an auxiliary lens to help increase light capture, the amount of light captured will also decrease as the distance increases. However, the amount of light captured at similar distances may be greater for the optical system with the auxiliary lens and the decrease in light captured may not drop as rapidly over distance. The increased light capture efficiency can be important because of the greater optical distances needed to combine the different colors of light produced by the various LEDs into a beam of white light.

With reference now to FIGS. 7a through 7c, there are shown diagrams illustrating exemplary aspheric auxiliary lenses, for which there can be several embodiments. In a first embodiment, shown in FIG. 7a, the auxiliary lens 505 may have a curved surface on the side of the auxiliary lens 505 facing a light source and a flat surface on a side of the auxiliary lens 505 that is not facing the light source. Alternatively, the auxiliary lens 505 can have a flat surface on the side of the auxiliary lens 505 facing the light source and a curved surface on the side of the auxiliary lens 505 that is not facing the light source, as shown in FIG. 7b. As shown in FIG. 7c, the auxiliary lens 505 can have a curved surface on both sides of the auxiliary lens 505.

With reference now to FIGS. 8a through 8d, there are shown diagrams illustrating exemplary auxiliary lens and fly-eye integrator configurations. As discussed previously, the auxiliary lens 505 can be placed in the optical path of the light engine 310 of the projection display system 300 in front of or behind a fly-eye integrator, such as the first fly-eye integrator 310. The auxiliary lens 505 can be placed in front of the first fly-eye integrator 310 with an air gap separating the two, as shown in FIG. 8a. Alternatively, the auxiliary lens 505 can be placed behind the first fly-eye integrator 310 with an air gap separating the two, as shown in FIG. 8b. A material other than air can be used to fill the gap present between the auxiliary lens 505 and the first fly-eye integrator 310. The material can help to reduce light loss due to reflection and refraction. For example, a fluid with similar refractive index as the auxiliary lens 505 and the first fly-eye integrator 310 may be preferred for this interface.

The auxiliary lens 505 and the first fly-eye integrator 310 can also be combined into a single unit. For example, the first fly-eye integrator 310 and the auxiliary lens 505 can be bonded together to form a single unit as shown in FIG. 8c. An adhesive having a similar refractive index as the auxiliary lens 505 and the first fly-eye integrator 310 would be preferred. Alternatively, the first fly-eye integrator 310 and the auxiliary lens 505 can be molded as a single unit as shown in FIG. 8d with the fly-eye integrator 310 formed on a first surface of the single unit and the auxiliary lens 505 formed on a second surface of the single unit. An advantage of bonding two different units together is the use of different materials for each unit, while the molding of a single unit will likely require the use of a single material.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An illumination system comprising:
a light source;
an integrating lens optically coupled to the light source, the integrating lens to condense light provided by the light source; and
an auxiliary lens optically coupled to the light source and positioned in a light path of the illumination system after the light source, the auxiliary lens configured to focus light incident on an outer periphery of the auxiliary lens towards an optical axis of the illumination system and to pass light incident on an optical center portion of the auxiliary lens substantially unaffected.

2. The illumination system of claim 1 further comprising a collimator lens optically coupled between the light source and the auxiliary lens, the collimator lens to produce substantially parallel light beams from the light produced by the light source.

3. The illumination system of claim 1, wherein the integrating lens comprises a fly-eye integrator.

4. The illumination system of claim 3, wherein the integrating lens comprises a first fly-eye integrator and a second fly-eye integrator arranged along an optical axis of the illumination system, and wherein the auxiliary lens is optically coupled between the light source and the first fly-eye integrator.

5. The illumination system of claim 4, wherein the auxiliary lens is optically coupled to the first fly-eye integrator.

6. The illumination system of claim 5, wherein there is a gap between the auxiliary lens and the first fly-eye integrator.

7. The illumination system of claim 5, wherein the auxiliary lens and the first fly-eye integrator are combined as a single physical lens.

8. The illumination system of claim 7, wherein the auxiliary lens and the first fly-eye integrator are formed as a single lens unit.

9. The illumination system of claim 3, wherein the integrating lens comprises a first fly-eye integrator and a second fly-eye integrator, both arranged along an optical axis of the illumination system, and wherein the auxiliary lens is optically coupled between the first fly-eye integrator and the second fly-eye integrator.

10. The illumination system of claim 1, wherein the auxiliary lens comprises an aspheric lens.

11. The illumination system of claim 10, wherein the aspheric lens is a third, fourth, or fifth order aspheric lens with a center portion that is substantially flat.

12. The illumination system of claim 1, wherein the auxiliary lens comprises a spherical lens.

13. The illumination system of claim 1, wherein the auxiliary lens is formed from a material selected from the group consisting of: plastic, glass, and combinations thereof.

14. A display system comprising:
a light source to produce multiple colors of light, the light source comprising,
a light element;
an integrating lens optically coupled to the light element, the integrating lens to condense light provided by the light element;
an auxiliary lens optically coupled to the light element and positioned in a light path of the light source after the light element, the auxiliary lens configured to focus light incident on an outer periphery of the auxiliary lens towards an optical axis of the light source and to pass light incident on an optical center portion of the auxiliary lens substantially unaffected;
an array of light modulators optically coupled to the light source and positioned in the light path after the auxiliary lens, the array of light modulators configured to produce images on a display plane by modulating light from the light source based on image data; and
a controller electronically coupled to the array of light modulators and to the light source, the controller configured to provide light commands to the light source and load image data into the array of light modulators.

15. The display system of claim 14, wherein the light source comprises multiple solid-state light elements, and the light source further comprises more than one wavelength separating filters, with each wavelength separating filter positioned in the light path of the light source between a respective solid-state light element and the integrating lens, the wavelength separating filter to combine light produced by the respective solid-state light element with light produced by other solid-state light elements.

16. The display system of claim 15, wherein the auxiliary lens is positioned in the light path between a pair of wavelength separating filters.

17. The display system of claim 14, wherein the auxiliary lens comprises a high-order aspheric lens.

18. The display system of claim 14, wherein the array of light modulators is a digital micromirror device.

19. A method of manufacturing a display system, the method comprising:
installing a light source configured to generate multiple colors of light, the light source installing comprising,
installing a light element configured to produce the multiple colors of light;
installing an integrating lens configured to condense light produced by the light element;
installing an auxiliary lens in the light path of the multiple colors of light after the light element, the auxiliary lens configured to focus light incident on an outer periphery of the auxiliary lens towards an optical axis of the light source and to pass light incident on an optical center of the auxiliary lens substantially unaffected;
installing a spatial light modulator in the light path of the multiple colors of light;
installing a lens system in the light path of the multiple colors of light between the auxiliary lens and the spatial light modulator; and
installing a controller configured to control the light source and the spatial light modulator.

20. The method of claim 19, wherein the light element comprises a plurality of light elements, with each respective light element capable of producing a color of light, the method further comprising installing a plurality of light guides configured to combine light produced by a respective light element with light produced by other light elements.
